(19) United States
(12) Patent Application Publication
(10) Pub. No.: US 2009/0222929 A1
(43) Pub. Date: Sep. 3, 2009

(54) METHOD, PROGRAM, AND SERVER FOR BACKUP AND RESTORE

(75) Inventors: Masanori NOGUCHI, Tokyo (JP); Kazuhiro KAIYA, Tokyo (JP); Kohji KAWAKAMI, Yokohama-shi (JP); Shinichi MATSUKAWA, Tokyo (JP); Norikazu HOSAKA, Tokorozawa-shi (JP); Akihiro KASAHARA, Sambu-gun (JP); Akira MIURA, Sagamihara-shi (JP); Shigeru MIYASHITA, Sodegaura-shi (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: KABUSHIKI KAISHA TOSHIBA

(21) Appl. No.: 12/393,757

(22) Filed: Feb. 26, 2009

(30) Foreign Application Priority Data
Feb. 29, 2008 (JP) 2008-050653
Jan. 29, 2009 (JP) 2009-018620

(51) Int. Cl. G06F 21/00; H04L 9/08

(52) U.S. Cl. 726/27; 380/278; 711/162

(57) ABSTRACT

A recording device which backs up a content α in a recording medium and a recording device which restores the content are registered in a server so as to belong to the same domain group. When the recording device tries to restore the content, the restore is permitted only when both the recording devices belong to the same domain group. When there is a refresh request of the domain group, the domain group is invalidated only when a refresh period has passed. When a refresh number recorded in the recording device is less than or equal to the refresh number recorded in the recording device, the recording device backs up and locally merges the content recorded in the recording device into the recording medium.

### CROSS-REFERENCE TO RELATED APPLICATIONS

This application is based upon and claims the benefit of priority from prior Japanese Patent Applications No. 2008-050653, filed Feb. 29, 2008; and No. 2009-018620, filed Jan. 29, 2009, the entire contents of both of which are incorporated herein by reference.

### BACKGROUND OF THE INVENTION

1. Field of the Invention

The present invention relates to a method, a program, and a server for backup and restore of a content protected by, for example, copyright.

2. Description of the Related Art

In these days, a technique for delivering content which is digital works of music, video, and games through the Internet and the digital broadcasting has been developed remarkably.

The content delivered through the Internet and digital broadcasting is received and recorded by a recording device such as an HDD recorder and a personal computer and in case of a failure or parts replacement in the recording device, a function for backup, restore, and merge is indispensable.

Backup means that the content recorded in the recording device is copied in another medium such as a CD and an HDD, restore means that the copied content is turned into a state reproducible in another recording device, and merge means that a content in the recording device is kept while another content recorded in another recording device is turned into a reproducible state.

When backup, restore, and merge are allowed without any restriction, however, it causes illegal copying of content. Needless to say, the illegal copying of the content is not allowed from the viewpoint of copyright protection.

Then, there arises a need for a technique of prohibiting the illegal copying of the content while achieving a user's convenience, by allowing the backup, restore, and merge under a certain constraint.

In JP-A 2000-309589(KOKAI), there are disclosed a technique of restricting copy and transfer only between a plurality of recording devices possessed by the same user and a technique of forming a group called domain in which copying and transfer are mutually possible.

The conventional method of restriction, however, has the following problems.

Specifically, since there is no restriction on the number of the recording devices that can be registered in a domain according to the technique disclosed in JP-A 2006-309589(KOKAI), copying can be performed in unlimited recording devices and as the result, the illegal copying is possible. In addition, there is a problem that it is short of user's convenience since it does not have any refresh mechanism and merge function.

### BRIEF SUMMARY OF THE INVENTION

The invention takes the following measures.

In other words, a first aspect of the invention is a method for restoring a content recorded in a first recording device, in a second recording device through a recording medium after backing up the content in the recording medium. In this method, the respective recording devices belonging to the same domain group are connected to a server through a communication network. The recording device permitted to back up the recorded content into the recording medium and the recording device permitted to restore the content from the recording medium are registered in the server so as to belong to the same domain group.

Next, when the content recorded in the first recording device is restored in the second recording device through the recording medium with the backup of the above content recorded, the server checks whether the first and second recording devices belong to the same domain group. When the first and second recording devices belong to the same domain group, the server permits the second recording device to restore the content; when the first and second recording devices do not belong to the same domain group, the server does not permit the second recording device to restore the content. When one of the recording devices connected to the server through the communication network requests the server to refresh the domain group, the server invalidates the domain group to which the recording device belongs, while keeping a history of the above domain group. The server holds a refresh prohibition period and when one of the recording devices registered in the same domain makes a request for refresh before the elapse of the refresh prohibition period, it does not permit the refresh.

In a second aspect of the invention, according to the method of the first aspect of the invention, when the invalidated domain group is refreshed, the server gives the domain group a fresh number. When the recording device belonging to the domain group, of the recording devices connected to the server, gains access to the server, the refresh number is obtained from the server.

In a third aspect of the invention, according to the method of the second aspect of the invention, when the refresh number recorded in the first recording device is not more than the refresh number recorded in the second recording device, the second recording device backs up the content which is recorded in the first recording device into the recording medium and then, merges the content through the recording medium.

In a fourth aspect of the invention, according to the method of any of the above first to third aspects, when one of the recording devices connected through the communication network requests the server to leave the domain group, the server deletes the registration of the recording device from the domain group and the content recorded in the recording device is deleted.

In a fifth aspect of the invention, according to the method of any of the above first to fourth aspects, the first recording device is registered in the server so as to belong to the domain group when backing up the content into the recording medium.

A sixth aspect of the invention is a computer readable medium that includes a program applied to a server which executes a method for restoring a content recorded in a first recording device, in a second recording device through a recording medium after backing it up in the recording medium.

The program makes a computer execute the following functions: a function of registering a recording device which is permitted to back up the recorded content in a recording medium and a recording device which is permitted to restore the content from the recording medium, so as to belong to the same domain group; a function of checking whether the first and second recording devices belong to the same domain group when the content recorded in the first recording device is restored in the second recording device from the recording medium with the backup of the above content recorded; a function of permitting the second recording device to restore the content when the first and second recording devices belong to the same domain group, as a result of the check; a function of not permitting the second recording device to restore the content when the first and second recording devices do not belong to the same domain group, as a result of the check; a function of, when one of the recording devices connected through the communication network makes a request to refresh the domain group, invalidating the domain group to which the recording device belongs, while keeping a history of the above domain group; and a function of holding a refresh prohibition period and not permitting the refresh when one of the recording devices registered in the same domain makes a request for refresh before elapse of the refresh prohibition period.

A seventh aspect of the invention is a server which executes a method for restoring a content recorded in a first recording device in a second recording device through a recording medium after backing up the content in the recording medium.

The server includes the following means: registration means for registering a recording device which is permitted to back up a recorded content into a recording medium and a recording device which is permitted to restore the content from the recording medium, in the same domain group; checking means for checking whether the first and second recording devices belong to the same domain group when the content recorded in the first recording device is restored in the second recording device from the recording medium with the backup of the above content recorded; restore permission means for permitting the second recording device to restore the content when the first and second recording devices belong to the same domain group, as a result of the check; restore non-permission means for not permitting the second recording device to restore the content when the first and second recording devices do not belong to the same domain group, as a result of the check; invalidation means for, when one of the recording devices connected through the communication network makes a request to refresh the domain group, invalidating the domain group to which the recording device belongs while keeping the history of the above domain group; and refresh non-permission means for holding a refresh prohibition period and not permitting the refresh when one of the recording devices registered in the domain group makes a request for refresh before the elapse of the refresh prohibition period.

An eighth aspect of the invention is a server which permits a plurality of reproduction devices registered in the same domain group to reproduce a content encrypted with a content key and having a domain group identification number inherent in a domain group. The server includes registration means, user key delivery means, and content key delivery means.

Upon receipt of a request for registration in the domain group from the reproduction device, together with the domain group identification number and the reproduction device identification number inherent in the reproduction device, the registration means records the reproduction device identification number related to the domain group identification number and registers the reproduction device in the domain group through recording the domain group identification number in the reproduction device of the registration request source.

The user key delivery means creates a user key for the reproduction device by using the reproduction device identification number when the reproduction device is registered in the domain group, records the created user key related to the reproduction device identification number of the reproduction device and delivers the above user key to the registered reproduction device.

The content key delivery means encrypts the content key by using the user key created by the user key delivery means and delivers the encrypted content key to the registered reproduction device so that this reproduction device encrypts the content with the encrypted content key.

In a ninth aspect of the invention, according to the server of the eighth aspect, when a reproduction device makes a request to reproduce a content permitted to be reproduced in the reproduction devices belonging to some domain group and when the domain group identification number recorded in the request source reproduction device is identical to the domain group identification number of the requested domain group, a user key is delivered from the user key delivery means to the reproduction device, and when the user key is identical to the user key having been delivered from the user key delivery means, the reproduction device decodes the encrypted content key with the user key, and decodes and reproduces the content with the decoded content key.

A tenth aspect of the invention, in the server according to the eighth or ninth aspect, further includes first checking means and registration cancellation means.

The first checking means checks whether the domain group identification number and the reproduction device identification number are recorded as being related to each other, upon receipt of a request for leaving the domain group together with the domain group identification number and the reproduction device identification number from the reproduction device registered in the domain group.

When the first checking means judges that the domain group identification number and the reproduction device identification number are recorded as being related to each other, the registration cancellation means deletes the related record of the domain group identification number and the reproduction device identification number as well as the domain group identification number recorded in the reproduction device, thereby canceling the registration of the reproduction device in the domain group.

In an eleventh aspect of the invention, in the server according to any of the eighth to tenth aspects, the domain group identification number, the user key, and the encrypted content key are recorded in the recording medium connected to the reproduction device, and the recording medium identification number inherent in the recording medium is used, instead of the reproduction device identification number inherent in the reproduction device, to further record the recording medium identification number in the recording medium.

A twelfth aspect of the invention, in the server according to any of the eighth to eleventh aspects, includes second checking means, refresh permission means, and fresh number giving means.

The second checking means checks whether the domain group identification number and the reproduction device identification number are recorded as being related to each other, upon receipt of a refresh request for requesting a registration cancel of all the reproduction devices registered in the domain group together with the domain group identification number and the reproduction device identification number from the reproduction device registered in the domain group.

The refresh permission means permits the refresh request when the second checking means judges that the domain group identification number and the reproduction device identification number are recorded as being related to each other and when the refresh request is made after the elapse of a predetermined period from the last refresh request.

When the refresh request is permitted by the refresh permission means, the refresh number giving means executes the refresh of the respective reproduction devices registered in the domain group by deleting all the related records of the domain group identification number and the reproduction device identification number, and records a refresh number indicating the cumulative times of executing the refresh in the respective reproduction devices and the content.

In a thirteenth aspect of the invention, in the server according to the twelfth aspect, when a reproduction device makes a request to reproduce a content permitted to be reproduced in the reproduction devices belonging to some domain group, and when the domain group identification number recorded in the reproduction device of the request source is identical to the domain group identification number of the requested domain group and the refresh number recorded in the content is older than the refresh number recorded in the reproduction device of the request source, the user key is used to decode the encrypted content key and the decoded content key is used to decode and reproduce the content.

In a fourteenth aspect of the invention, in the server according to one of the eighth to thirteenth aspects, the user key is delivered to the reproduction device through a protected communication channel.

According to the invention, it is possible to realize a method, a program, and a server for backup, restore, and merge capable of blocking illegal copying assuredly.

### BRIEF DESCRIPTION OF THE SEVERAL VIEWS OF THE DRAWING

FIG. 1 is a functional block diagram showing a structural example of a system carrying out a method for restricting backup and restore according to a first embodiment;

FIG. 2 is a functional block diagram showing a structural example of a server according to the first embodiment;

FIG. 3 is a flowchart showing the flow of the processing in a checking unit, a restore permission unit, and a restore prohibition unit according to the first embodiment;

FIG. 4 is a flowchart showing the flow of processing in an invalidation unit according to the first embodiment;

FIG. 5 is a flowchart showing the flow of processing in a registration deletion unit according to the first embodiment;

FIG. 6 is a flowchart showing the flow of processing of local merge according to the first embodiment;

FIG. 7 is a functional block diagram showing a structural example of a system which realizes the restore and merge according to a second embodiment;

FIG. 8 is a functional block diagram showing a structural example of a server according to the second embodiment;

FIG. 9 shows a system area, a protection area, and a user data area provided in a recording and reproduction device that is a PC according to the second embodiment;

FIG. 10 is a view showing the flow of processing to register a recording and reproduction device in a domain group according to the second embodiment;

FIG. 11 shows a system area, a protection area, and a user data area provided in a storing medium according to the second embodiment;

FIG. 12 is a schematic view showing the flow of processing to register a storing medium in a domain group according to the second embodiment;

FIG. 13 is a schematic view showing the flow of processing to obtain a key from a server according to the second embodiment;

FIG. 14 is a schematic view showing the flow of processing for content reproduction according to the second embodiment;

FIG. 15 is a view showing the flow of restore processing according to the second embodiment;

FIG. 16 is a data structure view for use in describing a backup method according to the second embodiment;

FIG. 17 is a view showing the flow of domain leaving processing according to the second embodiment;

FIG. 18 is a view showing the flow of refresh processing according to the second embodiment; and

FIG. 19 is a view showing the flow of local merge processing according to the second embodiment.

### DETAILED DESCRIPTION OF THE INVENTION

Hereinafter, the best mode for carrying out the invention will be described referring to the drawings.

### First Embodiment

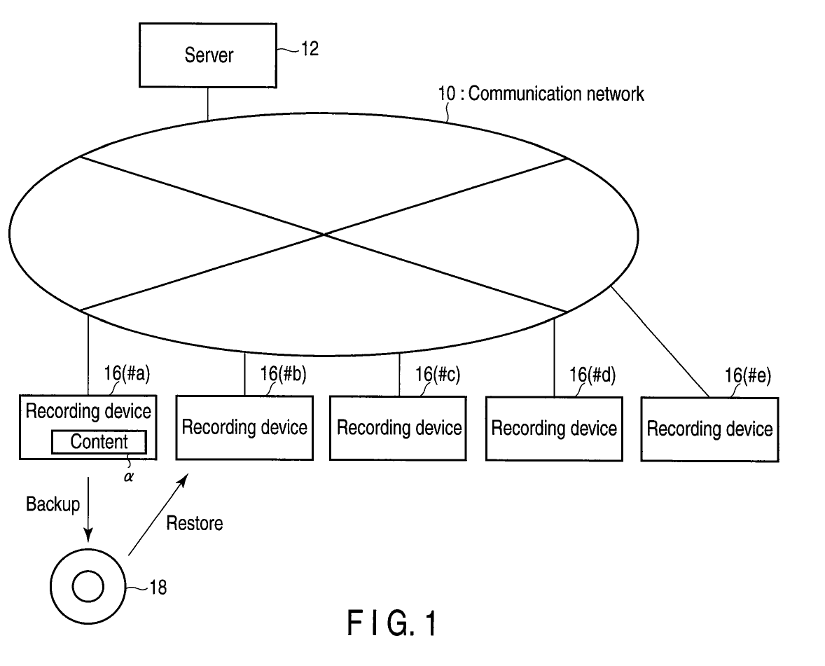

FIG. 1 is a functional block diagram showing a structure example of a system which realizes a method for backup and restore according to a first embodiment of the invention.

Specifically, the system which realizes the method for backup and restore according to the first embodiment is formed by a server 12 and a plurality of recording devices 16 connected with each other through a communication network 10 such as the Internet and a cable television line. Although FIG. 1 shows only five recording devices 16 (#a to #e), the number is not restricted to five but it may be more or less than five in the invention.

The network structure shown in FIG. 1 may be formed by LAN of the Ethernet (registered trademark) or WAN with a plurality of LANs connected thereto through a public line or a dedicated line. In the case of the LAN, it is structured by a large number of subnets through a router depending on necessity. In the case of the WAN, it includes a firewall for connecting to a public line properly but its illustration and specific description are omitted here.

After backing up a content α which has been recorded in the recording device 16 (#a) such as an HDD recorder or a personal computer into a recording medium 18 such as an HDD, a DVD, or a CD, the server 12 imposes various restrictions on the system to block the illegal copying in restoring the content α from the recording medium 18, for example, into the recording device 16 (#b) such as the HDD recorder or the personal computer.

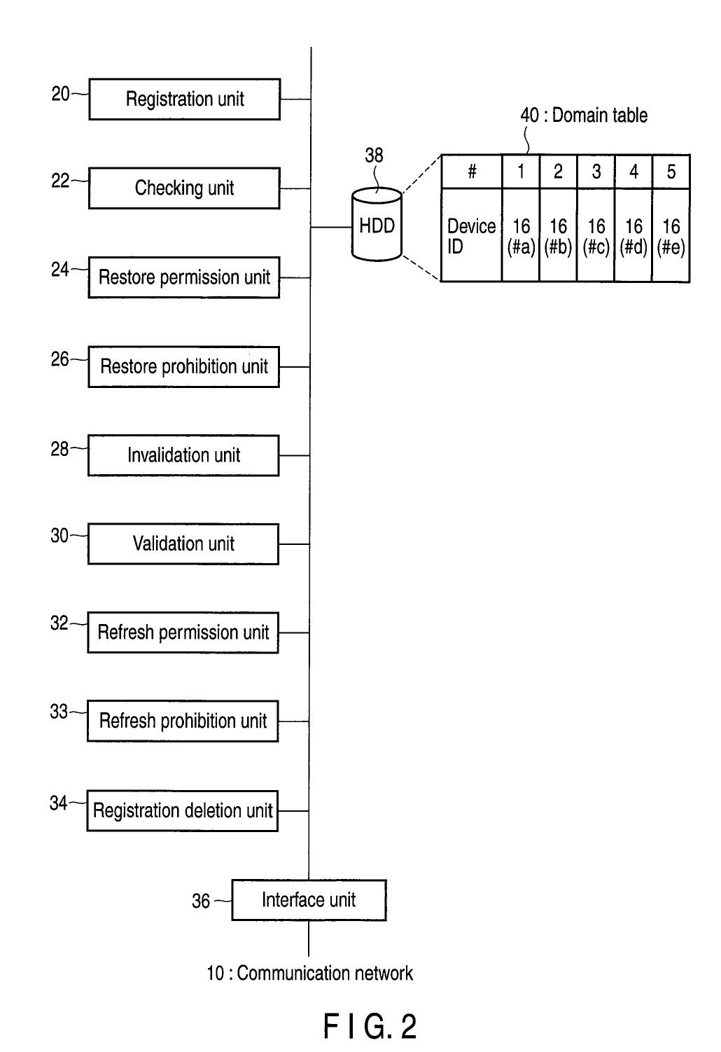

As shown in an example of the functional block diagram in FIG. 2, the server 12 includes a registration unit 20, a checking unit 22, a restore permission unit 24, a restore prohibition unit 26, an invalidation unit 28, a validation unit 30, a refresh permission unit 32, a refresh prohibition unit 33, a registration deletion unit 34, an interface unit 36, and a storage unit 38.

The registration unit 20 backs up the recorded content α into the recording medium 18, like the recording device 16 (#a) of FIG. 1 and registers a recording device permitted to restore the content from the recording medium 18 into a domain table 40 stored in the recording unit 38, like the recording device 16 (#b) of FIG. 1, so that they are in the same domain group. Though the recording unit 38 is formed by hardware such as an HDD and a memory, it is not restricted to the one built in the server 12 but it may be provided outside the server 12.

FIG. 2 shows an example of the domain table 40 with five recording devices 16 (#a, #b, #c, #d, #e) registered through writing their device IDs. It shows that the backup and the restore are allowed among these five recording devices 16 (#a, #b, #c, #d, #e).

In the backup of the content α in the recording medium 18, not only the content α, but also the device ID (stored for every recording device 16) of the recording device 16 of a backup source, the information of the domain table 40 (obtained from the server 12), and a refresh number (recorded for every recording device 16) described later are written in the recording medium 18. The refresh number is held in the refresh permission unit 32 and obtained from the server, as described later. Since the information of the domain table 40 is obtained from the server 12, the recording device 16 (#a) has to be registered in the server 12 in a state of belonging to the domain group when backing up the content α in the recording medium 18.

For example, when it does not belong to the domain group in the backup mode, the content α can be illegally copied in the following processes 1) to 4), but in this specification, since the recording device is requested to belong to the domain group in the backup mode, as mentioned above, the illegal copying is prevented in the procedure shown in the following 1) to 4).

1) Make a backup in the recording medium 18 when the recording device 16 (#a) does not belong to any domain group.

2) Register the recording device 16 (#a) in the domain group A and restore the content in the recording device 16 (#b) belonging to the same domain group.

3) Withdraw the recording device 16 (#a) from the domain group A.

4) Register the recording device 16 (#a) in the other domain group B and restore the backup made in the process 1) in the recording device 16 (#c) belonging to the domain group B.

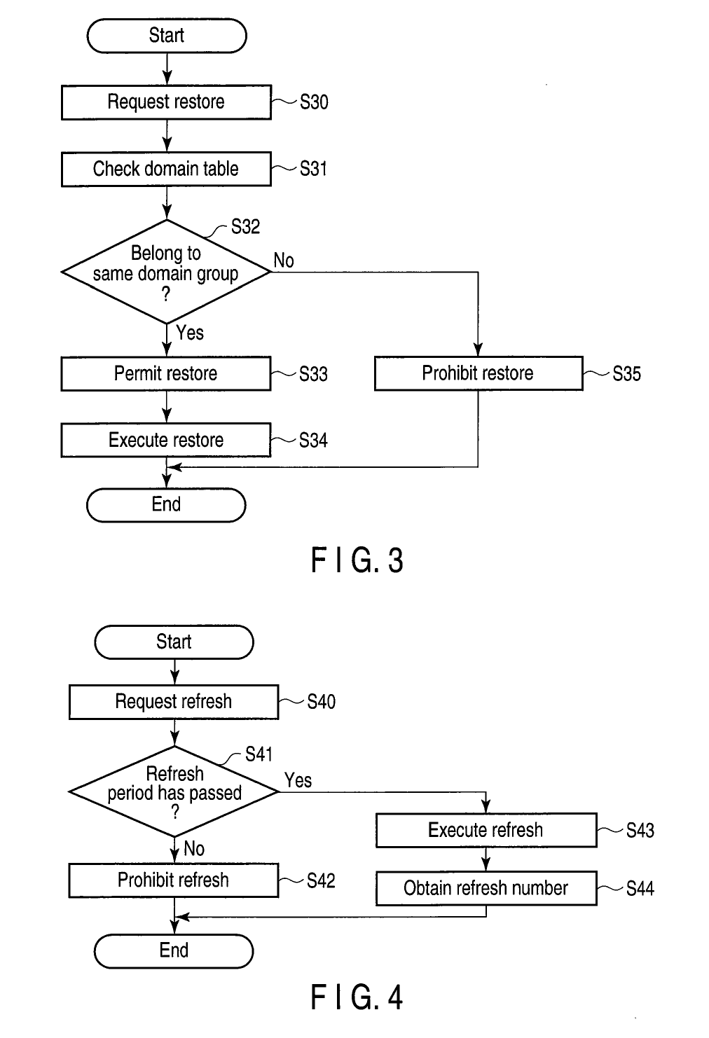

Next, the checking unit 22, the restore permission unit 24, and the restore prohibition unit 26 will be described with reference to the flowchart of FIG. 3.

The checking unit 22 checks whether the recording device 16 which tries to restore it is permitted or not. When the restore from the recording medium 18 which records the backup of the content α recorded in the recording device 16 (#a) into the recording device 16 (#b) is tried (S30), the checking unit 22 obtains the device ID of the recording device 16 (#a) written in the recording medium 18 and the device ID of the recording device 16 (#b) through the recording device 16 (#b) and checks whether the recording device 16 (#a) which has recorded the content α and the recording device 16 (#b) which tries to restore it belong to the same domain group (S31) with reference to the domain table 40.

As a result of the check by the checking unit 22, when both the recording devices 16 (#a) and 16 (#b) belong to the same domain group (S32: Yes), in other words, they belong to the same domain table 40, the restore permission unit 24 permits the recording device 16 (#b) to restore it (S33). In this case, a permission signal is transmitted from the interface unit 36 to the recording device 16 (#b) through the communication network 10. The recording device 16 (#b) receives the permission signal to restore the content α through the recording medium 18 (S34).

As a result of the check by the checking unit 22, when both the recording devices 16 (#a) and 16 (#b) do not belong to the same domain group (S32: No), in other words, they do not belong to the same domain table 40, the restore prohibition unit 26 does not permit the recording device 16 (#b) to restore it (S35). In this case, since the permission signal is not issued, the recording device 16 (#b) receives no permission signal and cannot restore the content α: through the recording medium 18.

Next, the invalidation unit 28 will be described with reference to the flowchart of FIG. 4.

When there is a request to refresh the domain group, in other words, to clear all the content of the domain table 40 from one of the recording devices 16 connected to the server 12 through the communication network 10, the invalidation unit 28 invalidates the domain group including the recording device 16 of the request source while holding the record of the above mentioned domain group for a predetermined period of time.

For example, when the recording device 16 (#a) makes a request to clear all the content of the domain group as shown in the domain table 40 (S40), it is checked whether the refresh prohibition period (for example, half year or one year) has passed in the domain group including the recording device 16 (#a) (S41), and thereafter the same domain group is invalidated. Although the domain table 40 with the domain group including the recording device 16 (#a) recorded therein is not deleted but kept, let the server 12 recognize that no domain group defined in the domain table 40 exists.

Such a refresh function is necessary in the following case. When the maximum number of the recording devices 16 which can be registered in the domain group is defined as five by way of example and when four of the five registered devices break down, neither backup nor restoration can be performed. In this case, the domain group is refreshed using the refresh function.

Namely, when the refresh of the domain group is performed without any restriction, a new domain registration is repeated with the backup kept in the recording medium 18 and the content will be copied illegally. In the embodiment, the refresh prohibition unit 33 fixes the refresh prohibition period such as half year or one year and even when receiving a refresh request from some of the recording devices 16 registered in the domain group (S40) before the elapse of the refresh keeping period, it checks whether the refresh prohibition period has passed or not (S41); when the refresh prohibition period has not passed (S41: No), it prohibits a new refresh (S42), hence to block the frequent refresh and the spread of the illegal copies.

On the other hand, when the refresh prohibition period has passed in Step S41 (S41: Yes), the refresh permission unit 32 refreshes the domain group (S43). A refresh number is obtained for every recording device 16 (#a to #e) belonging to the refreshed domain group from the interface unit 36 through the communication network 10 (S44). Upon receipt of the refresh number, each of the recording devices 16 (#a to #e) records the latest refresh number.

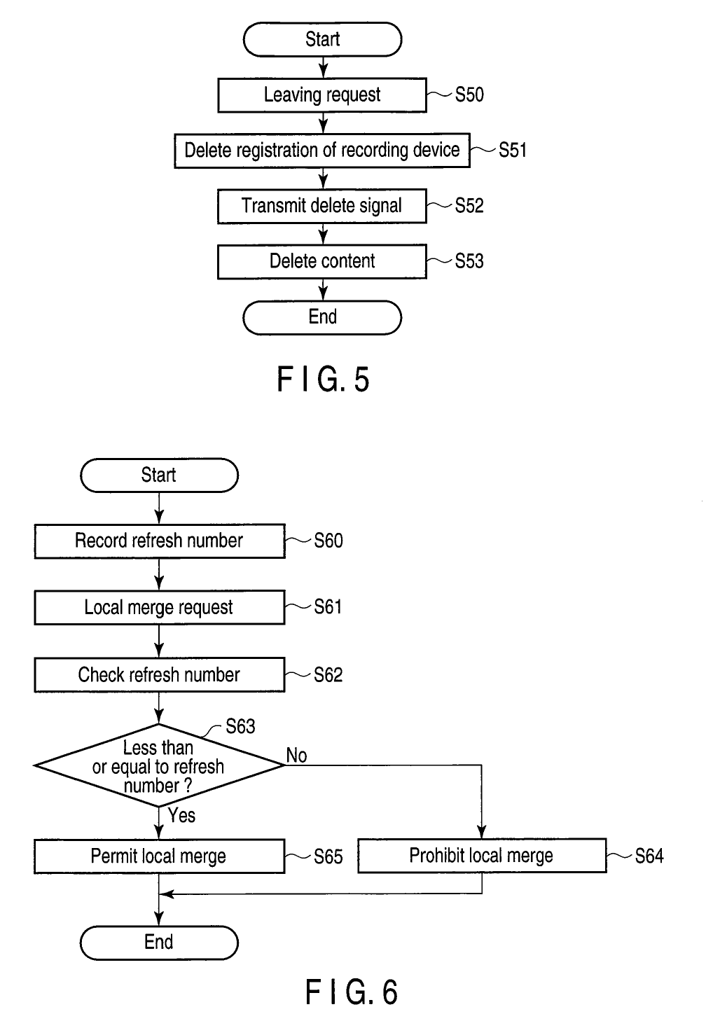

Next, the registration deletion unit 34 will be described with reference to the flowchart of FIG. 5.

When one of the recording devices 16 connected to the server 12 through the communication network 10 makes a request to leave the domain group (S50), the registration deletion unit 34 deletes the registration of the recording device 16 from the domain group (S51). For example, when the recording device 16 (#a) makes a request for leaving, the registration deletion unit 34 deletes the device ID of the recording device 16 (#a) from the domain table 40. Further, a content delete signal is transmitted from the interface unit 36 to the recording device 16 (#a) through the communication network 10 (S52). Upon receipt of the content delete signal, the recording device 16 (#a) deletes the recorded content α (S53). In this manner, the recording device 16 (#a) cannot back up or restore a content even when it is registered in a new domain group just after leaving, hence to block the spread of the illegal copies.

When a local merge of a content is performed between the recording devices 16, the recording device 16 which does the local merge checks whether the local merge is possible or not by comparison between the refresh numbers for the two relevant recording devices 16 as shown below. An example of the case where the local merge of the content α is performed from the recording device 16 (#a) to the recording device 16 (#b) will be described with reference to the flowchart of FIG. 6.

As mentioned above, the refresh number is also recorded in the recording medium 18 when the content α is backed up from the recording device 16 (#a) to the recording medium 18 (S60).

When the recording device 16 (#b) requests the local merge of the content α through the recording medium 18 (S61), the recording device 16 (#b) checks whether the refresh number of the recording device 16 (#a) included in the recording medium 18 is the refresh number of the recording device 16 (#b) or less (S62). When the refresh number of the recording device 16 (#a) is not the above (more than the refresh number of the recording device 16 (#b)) (S63: No), the local merge cannot be performed (S64). The refresh number of the recording device 16 (#a) is the refresh number of the recording device 16 (#b) or less (S64: Yes), the local merge is possible (S65).

Therefore, only the local merge into the recording device 16 in a new generation or the same generation is permitted while the local merge into the recording device 16 in an old generation is blocked. Since the local merge into the recording device 16 in the new generation means the local merge into the recording device 16 managed by the server 12, it is judged that there is little fear of spreading the illegal copies and the merge is permitted.

The operations of the respective units in the server 12 and the operations of the recording devices 16 are realized by a calculator (computer) whose operations are controlled by a program after reading the program recorded in a recording medium such as a magnetic disk or the program downloaded through a communication network such as the Internet.

The program (means of software) is to be executed by the calculator (computer), and it may be stored in the recording medium such as a magnetic disk (floppy (registered trademark) disk and hard disk), an optical disk (CD-ROM and DVD), and a semiconductor memory and delivered through the communication medium such as the Internet.

The program stored in the recording medium includes a setting program for configuring the software means of making the calculator execute (including not only the execution program, but also the table and the data structure) in the calculator.

Further, when the program is read from the recording medium or the communication medium to the calculator (computer), the calculator (computer) starts the operation to carry out the above-mentioned processing.

As mentioned above, in the method of the backup and the restore according to the embodiment, the server 12 can impose various restrictions for blocking the illegal copying when the content α is restored from the recording medium 18 to the recording device 16 (#b) such as an HDD recorder and a personal computer after the content α recorded in the recording device 16 (#a) such as the HDD recorder and the personal computer is backed up in the recording medium 18 such as HDD, DVD, and CD.

At first, since the recording device 16 (#a) always has to belong to a domain group when the recording device 16 (#a) makes a backup of the content α, it is possible to block the illegal copying according to the above mentioned processes 1) to 4).

Since the recording device 16 (#b) which can restore the content α using the backup made by the recording device 16 (#a) is limited to that registered in the same domain table 40, the spread of the illegal copies can be blocked.

Further, since the server 12 includes the function of refreshing the domain group, it can refresh the domain group even when only one of the recording devices 16 registered in the domain group is available because of failure, and therefore both the backup and the restore can be performed.

After the refresh prohibition period (half year or one year) has passed, the domain group is refreshed. A new refresh cannot be performed until then, which makes it possible to block the illegal copying accompanying the frequent refresh. Namely, unlimited refresh of the domain group causes a repetition of new domain registration while keeping a backup in the recording medium 18, which allows the illegal copy of a content; in the embodiment, however, a new domain group cannot be set before a predetermined period passes, thereby blocking the frequent refresh and the spread of the illegal copies.

Further, in the embodiment, the local merge of a content can be performed between the recording devices 16, but the possibility of the local merge is checked by comparison of the cumulative number of times of transmitting a refresh signal between the two relating recording devices 16, on the side of the recording device 16 which makes the local merge. Only when the cumulative number of the times in the recording device 16 (#a) with the content α recorded is not more than the cumulative number of the times in the locally-merged recording device 16 (#b), the local merge is permitted, thereby blocking the local merge into the recording device 16 of the old generation.

### Second Embodiment

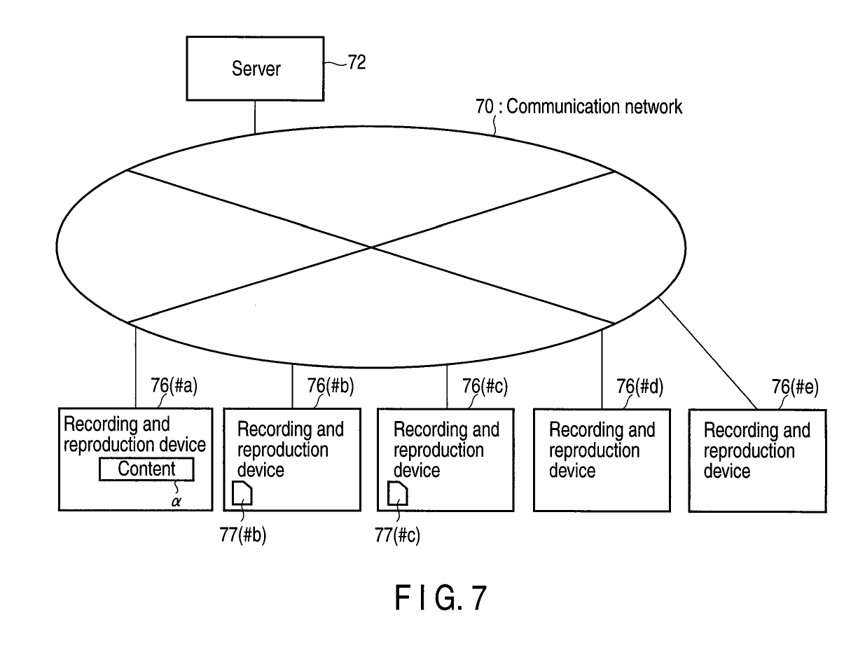

FIG. 7 is a functional block diagram showing a structural example of a system which realizes the restore and merge according to a second embodiment of the invention.

In other words, the system which realizes the restore and the merge according to the second embodiment has a server 72 and a plurality of recording and reproduction devices 76 mutually connected to each other through a communication network 70 such as the Internet and a cable television network. Although only five recording and reproduction devices 76 (#a to #e) are shown in FIG. 7, the number of the devices is not restricted to five but it may be more or less than five in the invention.

The network structure shown in FIG. 7 may be formed by LAN such as the Ethernet (registered trademark) or WAN with a plurality of LANs connected thereto through a public line or a dedicated line. In the case of the LAN, it includes a plurality of subnets through a router depending on the necessity. In the case of the WAN, it includes a firewall for connecting to the public line properly, but its illustration and specific description are omitted here.

The server 72 imposes various restrictions on the system to block the illegal use when the content α recorded in the recording and reproduction device 76 (#a) such as an HDD recorder or a personal computer is restored and merged in the other recording and reproduction devices 76 (#b to #d) such as an HDD recorder or a personal computer. In addition, the content α is recorded not only in the HDD recorder or the personal computer but also in the recording medium such as CD and DVD. Further, it may be recorded in the recording medium such as CD and DVD for the backup from the HDD recorder or the personal computer. The content α is encrypted by the following content key and stores the domain ID inherent in the domain group.

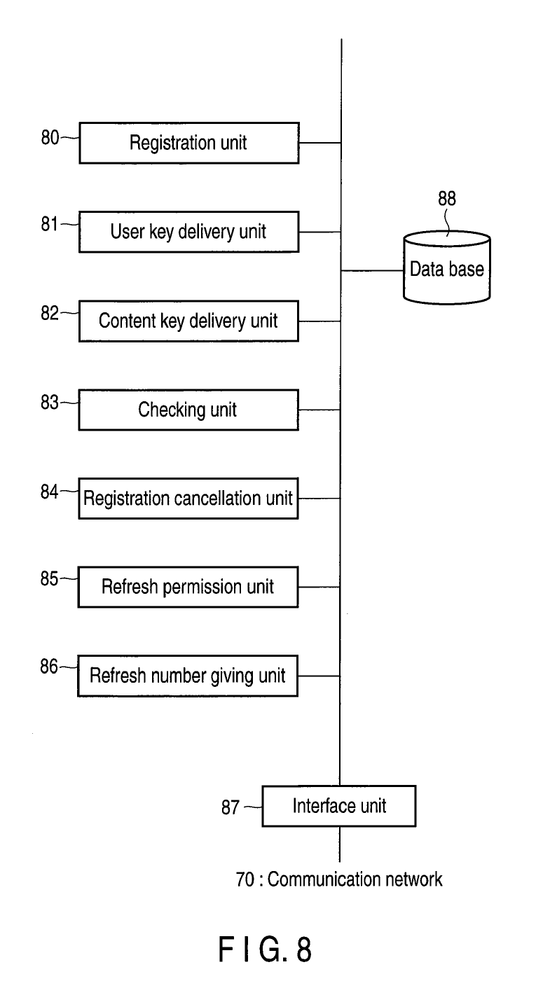

As shown in an example of the functional block diagram in FIG. 8, the server 72 includes a registration unit 80, a user key delivery unit 81, a content key delivery unit 82, a checking unit 83, a registration cancellation unit 84, a refresh permission unit 85, a refresh number attachment unit 86, an interface unit 87, and a database 88 configured in the recording medium such as HDD. The interface unit 87 is connected to the communication network 70 for communication between the server 72 and the respective recording and reproduction devices 76. Although FIG. 8 shows the example with these components all included in one server 72, all the components are not necessarily included in one server but they may be dispersed to a plurality of servers.

The registration unit 80 registers the recording and reproduction devices 76 (#a to #e) in the domain group as described in the first embodiment.

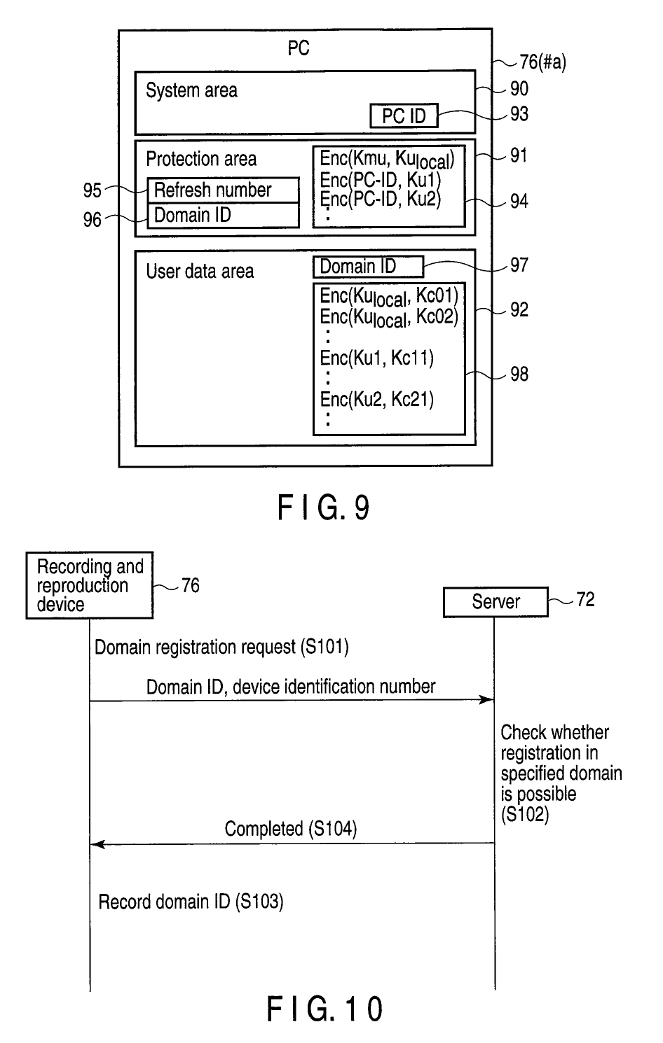

As an example, the case of registering the recording and reproduction device 76 (#a) that is the PC in the domain group will be described. As shown in FIG. 9, the recording and reproduction device 76 (#a) that is the PC includes a system area 90, a protection area 91, and a user data area 92. The system area means an area where data is not rewritten after being recorded, and the protection area means an area where data is correctly read and written through only the application's access. The user data area means an area readable and writable by anyone, such as HDD. Their installation can be realized by the method disclosed in, for example, JP-A 2008-234597(KOKAI).

The system area 90 stores the identification number (for example, PC-ID issued by the server) 93 inherent in the recording and reproduction device 76 (#a).

The protection area 91 stores the encrypted user key 94, the refresh number 95, and the domain ID 96 that is the identification number inherent in each domain group. In the user key 94, Enc (Kmu, Ku_{local}) indicates that Ku_{local} (user key for local content) is encrypted by Kmu (media unique key); Enc (PC-ID, Ku₁) indicates that Ku₁ (user key (ID=1)) is encrypted by the PC-ID 93; and Enc (PC-ID, Ku₂) indicates that Ku₂ (user key (ID=2)) is encrypted by the PC-ID 93. Here, the Kmu is the key derived from the identification number by the corresponding application, and it can be calculated, for example, by Kmu=Enc (application secret key, PC-ID) xor PC-ID. The refresh number 95 shows the cumulative times of the following refresh processing and it is given by the refresh number attachment unit 86. Before the registration into the domain group, the domain ID 96 is not stored.

The user data area 92 stores the domain ID 97 and the encrypted content key 98. The domain ID 97 is the same as the domain ID 96. Therefore, before the registration into the domain group, also the domain ID 97 is not stored. In the content key 98, Enc (Ku_{local}, Kc₀₁) indicates that Kc₀₁ (content key (ID=1)) is encrypted by Ku_{local} (user key for local content); Enc (Ku_{local}, Kc₀₂) indicates that Kc₀₂ (content key (ID=2)) is encrypted by Ku_{local} (user key for local content); Enc (Ku₁, Kc₁₁) indicates that Kc₁₁ (content key (ID=11)) is encrypted by Ku₁ (user key (ID=1)); and Enc (Ku₂, Kc₂₁) indicates that Kc₂₁ (content key (ID=21)) is encrypted by Ku₂ (user key (ID=2)).

The refresh number 95 and the domain ID 96 stored in the protection area 91 as mentioned above may be stored in the user data area 92.

When the recording and reproduction device 76 (#a) makes a request to register in the domain group, it transmits the registration request to the server 72 (S101), together with the domain ID of the registration desired domain group and the PC-ID 93 that is the identification number inherent in the recording and reproduction device 76 (#a), as shown in FIG. 10. In this case, they are transmitted through a protected communication channel 70. The registration request is received by the interface unit 87 of the server 72 and transferred to the registration unit 80.

The registration unit 80 checks whether the registration-requested domain ID can be registered or not (S102); when it can be registered, the registration unit 80 records the above domain ID together with the related PC-ID 93 transmitted from the recording and reproduction device 76 (#a) in the database 88. In this case, the identification number of the recording and reproduction device 76 belonging to the same domain group may be recorded in the same domain table 40, as shown in FIG. 1. The registration unit 80 further records the domain ID in the protection area 91 and the user data area 92 of the recording and reproduction device 76 (#a) as the domain IDs 96 and 97 (S103). Therefore, the registration of the recording and reproduction device 76 (#a) into the domain group is completed (S104).

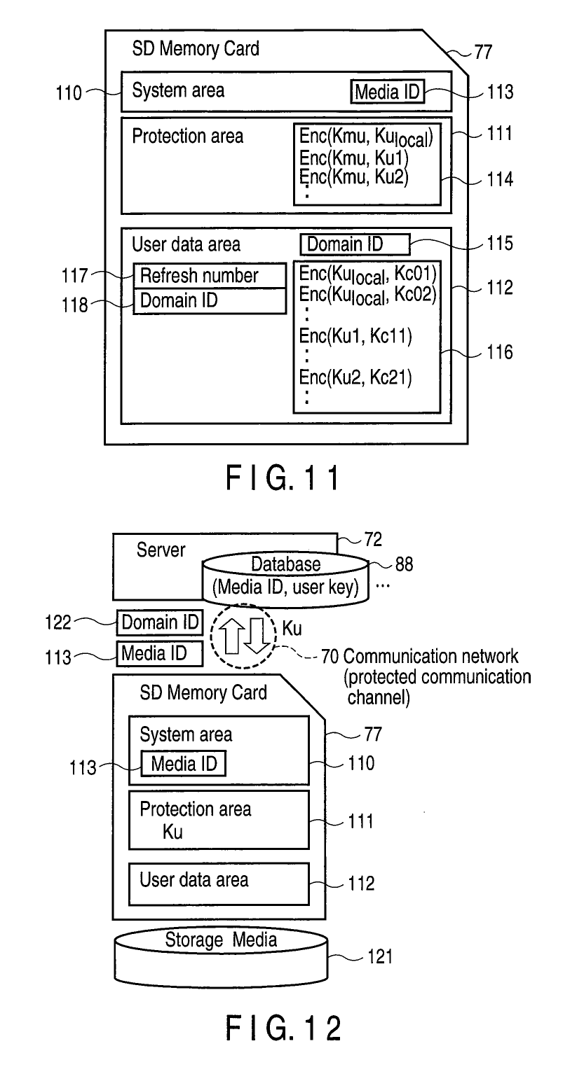

As another example, the case of registering the recording and reproduction device 76 (#b) with the recording medium 77 (#b) such as a memory card inserted, in the domain group, will be described. As shown in FIG. 11, the memory card such as an SD card includes a system area 110, a protection area 111, and a user data area 112. The properties of the respective areas are similar to those of the system area 90, the protection area 91, and the user data area 92, respectively. Its installation can be realized by the method disclosed in, for example, Content Protection for Recordable Media Specification for SD Memory Card, Revision 0.961, May 3, 2007. http://www.4centity.com/.

The system area 110 stores a media ID 113 that is the identification number inherent in the memory card 77.

The protection area 111 stores the encrypted user key 114. Here, Enc (Kmu, Ku_{local}) shows that Ku_{local} (user key for local content) is encrypted by Kmu (media unique key); Enc (Kmu, Ku₁) shows that Ku₁ (user key (ID=1)) is encrypted by Kmu; and Enc (Kmu, Ku₂) shows that Ku₂ (user key (ID=2)) is encrypted by Kmu.

The user data area 112 stores a domain ID 115, an encrypted content key 116, a refresh number 117, and a domain ID 118. The domain ID 115 and the domain ID 118 are the same and they are not recorded before their registration in the domain group. In the content key 116, Enc (Ku_{local}, Kc₀₁) shows that Kc₀₁ (content key (ID=1)) is encrypted by Ku_{local} (user key for local content); Enc (Ku_{local}, Kc₀₂) shows that Kc₀₂ (content key (ID=2)) is encrypted by Ku_{local} (user key for local content); Enc (Ku₁, Kc₁₁) shows that Kc₁₁ (content key (ID=11)) is encrypted by Ku₁ (user key (ID=1)); and Enc (Ku₂, Kc₂₁) shows that Kc₂₁ (content key (ID=21)) is encrypted by Ku₂ (user key (ID=2)). Similarly to the refresh number 95, the refresh number 117 shows the cumulative times of the refresh processing and is given by the refresh number attachment unit 86.

The refresh number 117 and the domain ID 118 stored in the user data area 112 as mentioned above may be stored in the protection area 111.

When the recording and reproduction device 76 (#b) makes a request to register in the domain group, it transmits a registration request to the server 72 through the communication network 70 that is the protected communication channel together with the desired domain ID 122 and the media ID 113 of the recording medium 77 (#b) inserted in the recording and reproduction device 76 (#b), as illustrated in FIG. 12. The registration request is received by the interface unit 87 and transferred to the registration unit 80.

The registration unit 80 checks whether the registration into the requested domain ID is possible or not, and when it is possible, it records the requested domain ID and the media ID 113 transmitted from the recording and reproduction device 76 (#b) which are related to each other, in the database 88. In this case, the identification numbers of the recording and reproduction devices 76 and the storing medium 77 belonging to the same domain group may be stored in the same domain table 40 as shown in FIG. 2. The registration unit 80 records the domain ID in the user data area 112 of the recording medium 77 (#b) as the domain IDs 115 and 118. In this way, the recording and reproduction device 76 (#b) with the recording medium 77 (#b) inserted therein has been registered in the domain group.

When the recording and reproduction device 76 has been registered in the domain group in this way, the user key delivery unit 81 generates the user key Ku for the recording and reproduction device 76, using the PC-ID 93 or the media ID 113. For example, it generates the user key Ku for the recording and reproduction device 76 (#a) using the PC-ID 93 while it generates the user key Ku for the recording and reproduction device 76 (#b) with the recording medium 77 (#b) inserted therein, using the media ID 113. The thus generated user key Ku is recorded in the database 88, related to the PC-ID 93 or the media ID 113, and transmitted to the corresponding recording and reproduction device 76 from the interface unit 87 through the communication network 70. Also, in this case, it is delivered through the communication network 70 that is the protected communication channel.

The user key Ku delivered to the recording and reproduction device 76 (#a) that is the PC, is recorded in the protection area 91 and the user key Ku delivered to the recording and reproduction device 76 (#b) with the recording medium 77 (#b) such as a memory card inserted therein is recorded in the protection area 111, as shown in FIG. 12.

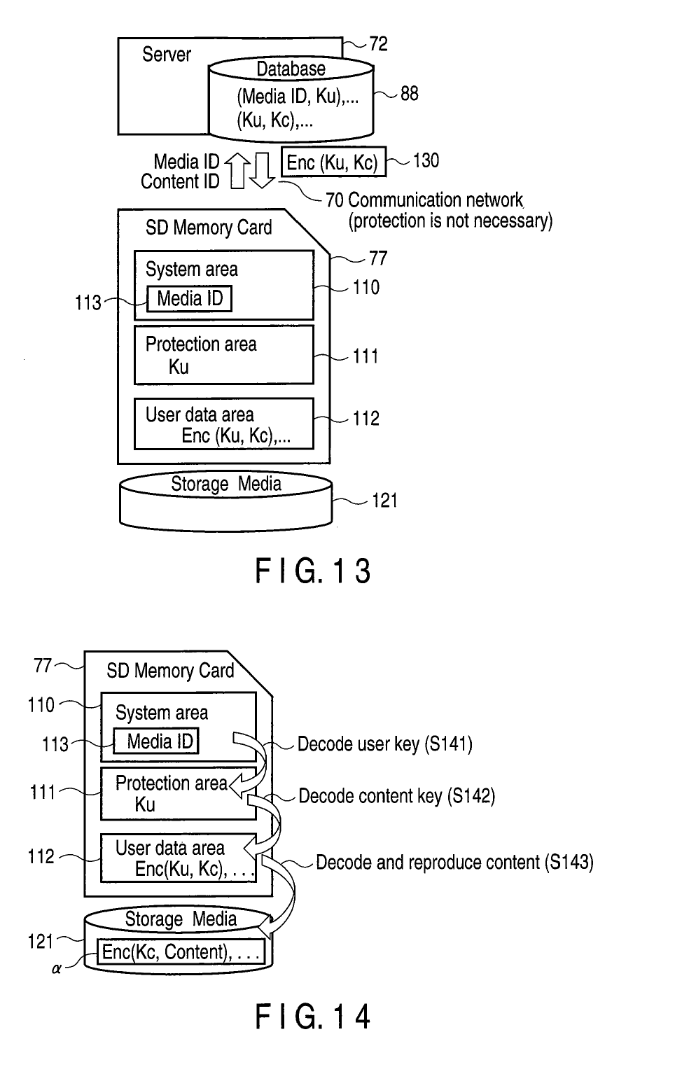

The content key delivery unit 82 encrypts the content key Kc by using the user key Ku generated by the user key delivery unit 81 and transmits the encrypted content key Enc (Ku, Kc) 130 from the interface unit 87 to the corresponding recording and reproduction device 76 through the communication network 70, as shown in FIG. 13. In this case, the communication network 70 does not have to be protected.

The content key (Enc (Ku, Kc)) delivered to the recording and reproduction device 76 (#a) that is the PC is recorded in the user data area 92 and the content key Enc (Ku, Kc) 130 delivered to the recording and reproduction device 76 (#b) with the recording medium 77 (#b) such as a memory card inserted is recorded in the user data area 112, as shown in FIG. 13. These content keys are used by the recording and reproduction device 76 (#a) for coding and decoding of the content α stored in, for example, the recording medium 121.

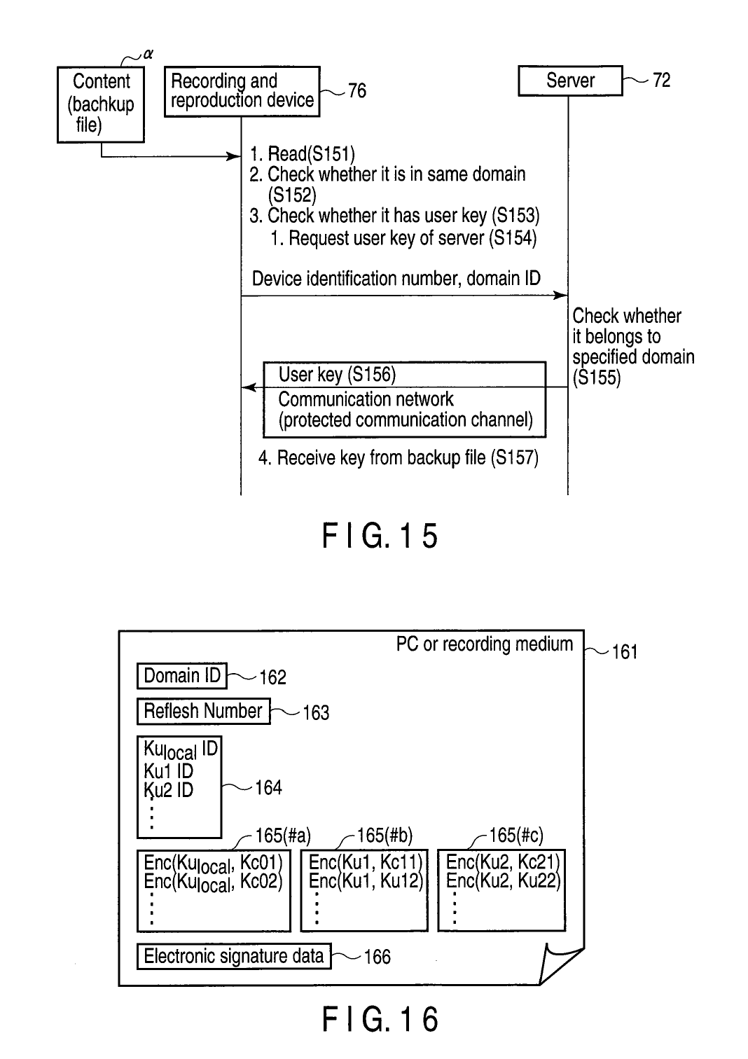

Next, the flow of the processing when the server 72 permits a plurality of recording and reproduction devices 76 (#a to #e) registered in the same domain group to reproduce a content will be described with reference to FIGS. 14 and 15.

The recording and reproduction device (recording and reproduction device 76 (#c) with the recording medium 77 (#c) such as a memory card inserted) reads the encrypted content α (Enc (Kc, Content)) stored in the recording medium 121 in order to reproduce it (S151) and checks whether the domain ID 96 or the domain ID 115 recorded in the recording and reproduction device 76 (#c) or the recording medium 77 (#c) inserted into the recording and reproduction device 76 (#c) is identical to the domain ID of the domain group to which the content α belongs (S152). When it does, it checks whether the recording medium 77(#c) has the user key Ku (S153). When the recording medium 77 (#c) has the user key Ku, the recording and reproduction device 76 (#c) transmits a request for issuing the user key Ku to the server 72 together with the media ID 113 and the domain ID (S154). The checking unit 83 of the server 72 searches the database 88 in order to check whether the media ID 113 is registered in the corresponding domain ID (S155). When it is registered, the user key delivery unit 81 generates the user key Ku from the media ID 113 and delivers it from the interface unit 87 to the recording and reproduction device 76 (#c) through the communication network 70 (protected communication channel) (S156).

When the delivered user key Ku is identical to the user key Ku which has already been delivered in the registration, the recording and reproduction device 76 (#c) decodes the encrypted content key Enc (Ku, Kc) by using the user key Ku (S157), decodes and reproduces the encrypted content α (Enc (Kc, Content)) by using the decoded content key Kc.

Although the above-mentioned description with reference to FIG. 14 is targeted for the recording and reproduction device 76 (#c) with the recording medium 77 (#c) such as a memory card inserted therein, it will be understood by those skilled in the art that it can be similarly applied to the recording and reproduction device such as a PC which does not use the recording medium such as a memory card.

Next, a method of backup will be described using the data structure view in FIG. 16. The data written in the PC or the recording medium 161 of the backup target, such as the domain ID 162, the refresh number 163, a plurality of user key IDs 163, a plurality of encrypted content keys (for example, the encrypted content key 165 (#a) of the local content, and the encrypted content keys 165 (#b), 165 (#c), . . . of the delivery content), is written as a backup file. Further, electronic signature data 166 may be added in order to detect tampering of data or errors.

A method of restore using the backup file will be described. A device that wants to restore the data reads the data from the backup file. First, it checks whether the domain ID 162 is the same as that of this device. In the case of mismatch, the data is regarded as another domain's data and the processing is aborted. Next, the refresh number 163 is checked to judge whether the restore is possible or not by comparing the above with that of this device. When the refresh number 163 of this device is smaller, the restore processing is aborted. Then, the user key ID 164 is checked and when there is some user key that this device does not have, that user key is downloaded. Finally, the encrypted content key 165 is recorded in the PC or the recording medium 165.

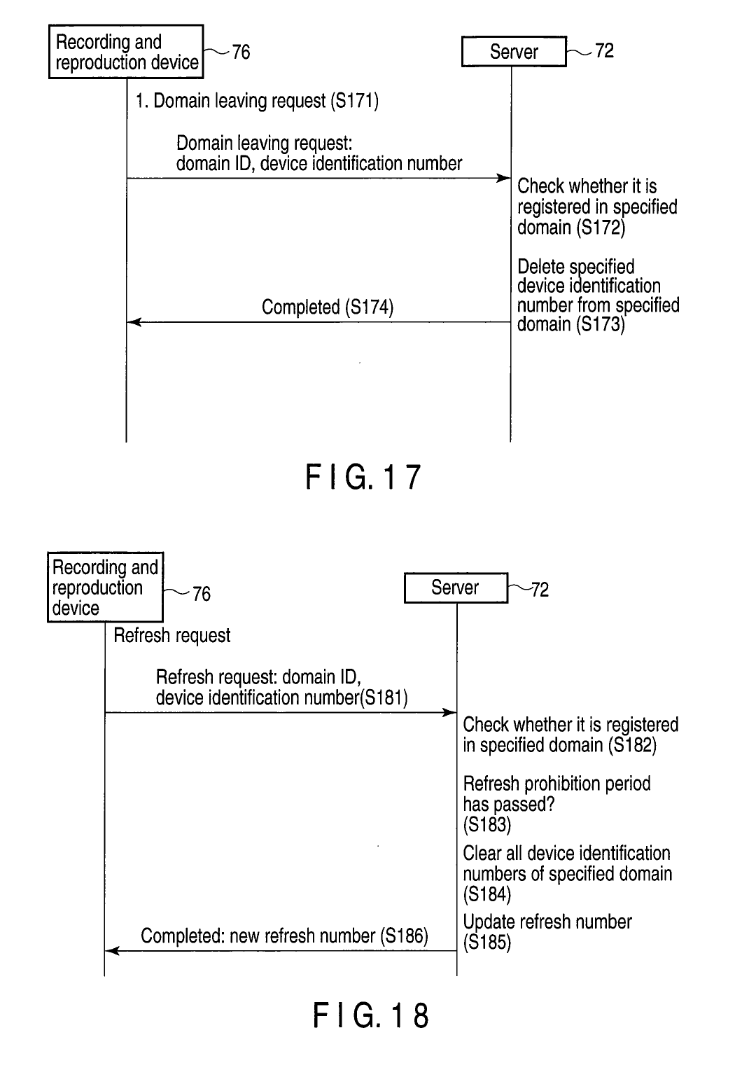

Next, the processing of leaving the domain group or releasing the registration after the recording and reproduction device 76 is once registered in the domain group will be described with reference to FIG. 17.

The recording and reproduction device 76 (for example, the recording and reproduction device 76 (#d)) that wants to leave the domain transmits a request for leaving domain to the server 72 together with the domain ID of the domain group to which this device belongs and the identification number such as the PC ID 93 or the media ID 113 (S171).

When the server 72 receives this request in the interface unit 87, the checking unit 83 checks whether the domain ID transmitted with the domain leaving request is recorded in the database 88, related to the identification number such as the PC-ID 93 or the media ID 113 (S172). When it is recorded as being related to it, the registration cancellation unit 84 deletes the identification number (PC-ID 93 or media ID 113) of the recording and reproduction device 76 (#d) recorded as being related to this domain ID (S173) and the domain leaving processing is completed (S174).

The refresh processing to refresh the domain group will be described with reference to FIG. 18. The refresh processing is to cancel the registration of all the recording and reproduction devices 76 registered in the same domain group.

Specifically, when the recording and reproduction device 76 that has already been registered in the domain group transmits a refresh request to the server 72 together with the domain ID of the domain group and the identification number (PC-ID 93 or media ID 113) of the recording and reproduction device 76 (S181), the checking unit 83 of the server 72 checks whether the specified domain ID is recorded in the database 88 as being related to the identification number of the recording and reproduction device 76 (S182). When it is judged that it is related and stored, the refresh permission unit 85 checks whether this refresh request is transmitted after a predetermined refresh prohibition period has passed from the last refresh request (S183). When it is transmitted after the elapse of the period, it permits the refresh request.

When the refresh permission unit 85 permits the refresh request, the refresh number attachment unit 86 clears all the recorded identification numbers of all the recording and reproduction devices 76 related to the specified domain ID, hence to carry out the refresh (S184), updates the refresh number showing the cumulative times of performing the refresh (S185), and makes each of the refreshed recording and reproduction devices 76 and the content record the updated refresh number (S186). Therefore, the refresh processing is completed.

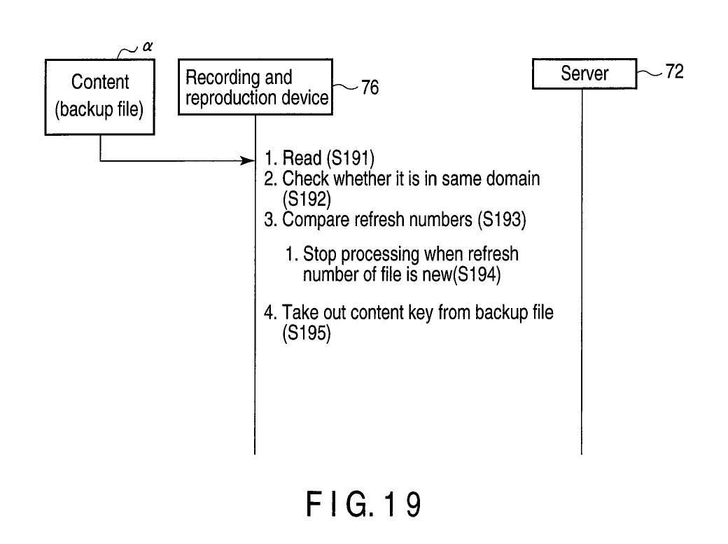

The local merge processing will be described with reference to FIG. 19. In the local merge processing, a recording and reproduction device (recording and reproduction device of a request source) 76 tries to reproduce a content which is permitted to reproduce in the recording and reproduction devices belonging to some domain group and reads the content (S191). The recording and reproduction device 76 of the request source checks whether the domain ID recorded in this recording and reproduction device 76 is identical to the domain ID of the reproduction-requested domain group, in other words, the domain ID of the content α (S192). When the recording and reproduction device 76 of the request source confirms the identification of the both domain IDs, it compares the refresh number recorded in the content with the refresh number recorded in the request-source recording and reproduction device 76 (S193).

In this case, when the refresh number recorded in the content α is newer than the refresh number recorded in the request-source recording and reproduction device 76, the following processing is stopped (S194). On the other hand, when the refresh number recorded in the content α is older than that recorded in the request-source recording and reproduction device 76, the request-source recording and reproduction device 76 decodes the encrypted content key Kc with the user key Ku and decodes the content with the decoded content key Kc, hence to reproduce the content (S195).

The above operations of the respective units in the server 72 and the operations of the recording and reproduction device 76 are realized by a calculator (computer) whose operations are controlled by the program after reading out a program recorded in a recording medium such as a magnetic disk or a program downloaded through a communication network such as the Internet.

The program (software means) is executable by a calculator (computer), and it may be stored in the recording medium such as a magnetic disk (floppy (registered trademark) disk and hard disk), optical disk (CD-ROM and DVD), and a semiconductor memory, alternatively it may be delivered through the communication medium such as the Internet.

The program recorded in the recording medium includes a setting program for configuring in a calculator, software means executable by the calculator (including not only executing program but also table and data structure).

Further, when the program is read from the recording medium or the communication medium by a calculator (computer), the above mentioned processing is executed by operating the calculator (computer).

According to the system of the above mentioned embodiments, when the content α recorded in the recording and reproduction device 76 (#a) such as an HDD recorder and a personal computer is reproduced in another recording and reproduction device such as an HDD recorder and a personal computer, the server 72 can block not only the illegal copying but also illegal reproduction effectively through the application of the encryption technique, in addition to the effect achieved in the first embodiment.

As mentioned above, although the best mode for carrying out the invention has been described with reference to the attached drawings, the invention is not limited to the structure. In a range of developed technique in the claims, those skilled in the art can conceive of various modifications and the corrected examples and these modifications and corrected examples are allowed as belonging to the technical range of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for restoring a content recorded in a first recording device, in a second recording device through a recording medium after backing up the content in the recording medium, comprising:
registering the first recording device which is permitted to back up a recorded content into a recording medium and the second recording device which is permitted to restore the content from the recording medium, in a server as the same domain group;
connecting the respective recording devices belonging to the same domain group to the server through a communication network;
the server checking whether the first and second recording devices belong to the same domain group when the content recorded in the first recording device is restored in the second recording device through the recording medium with the backup of the above content recorded;
the server permitting the second recording device to restore the content when the first and second recording devices belong to the same domain group;
the server not permitting the second recording device to restore the content when the first and second recording devices do not belong to the same domain group;
when one of the recording devices connected to the server through the communication network requests the server to refresh the domain group, the server invalidating the domain group to which the recording device belongs, while keeping history of the above domain group; and
the server holding a refresh prohibition period and not permitting the refresh when one of the recording devices registered in the same domain group makes a request for refresh before elapse of the refresh prohibition period.

2. The method according to claim 1, further comprising:
the server giving a refresh number to the domain group when the invalidated domain group is refreshed; and
acquiring the refresh number from the server when the recording device belonging to the domain group, of the recording devices connected to the server, gains access to the server.

3. The method according to claim 2, wherein
when a refresh number recorded in the first recording device is not more than the refresh number recorded in the second recording device, the second recording device backs up the content recorded in the first recording device into the recording medium and then, merges the content through the recording medium.

4. The method according to claim 1, wherein
when one of the recording devices connected through the communication network notifies the server that it wants to leave the domain group, the server deletes the registration of the recording device from the domain group and the content recorded in the recording device is deleted.

5. The method according to claim 1, wherein
the first recording device is registered in the server so as to belong to the domain group when backing up the content into the recording medium.

6. A computer readable medium which includes a program applied to a server which executes a method for restoring a content recorded in a first recording device in a second recording device through a recording medium after backing up the content in the recording medium, the program comprising:
a function of registering a recording device which is permitted to back up a recorded content into a recording medium and a recording device which is permitted to restore the content from the recording medium, in the same domain group;
a function of checking whether the first and second recording devices belong to the same domain group when the content recorded in the first recording device is restored in the second recording device through the recording medium with the backup of the above content recorded;
a function of permitting the second recording device to restore the content when the first and second recording devices belong to the same domain group, as a result of the check;
a function of not permitting the second recording device to restore the content when the first and second recording devices do not belong to the same domain group, as a result of the check;
a function of, when one of the recording devices connected through the communication network makes a request to refresh the domain group, invalidating the domain group to which the recording device belongs, while keeping a history of the above domain group; and
a function of holding a refresh prohibition period and not permitting the refresh when one of the recording devices registered in the same domain group makes a request for refresh before elapse of the refresh prohibition period.

7. A server which executes a method for restoring a content recorded in a first recording device in a second recording device through a recording medium after backing up the content in the recording medium, comprising:
registration means for registering the first recording device which is permitted to back up a recorded content into a recording medium and the second recording device which is permitted to restore the content from the recording medium, in the same domain group;
checking means for checking whether the first and second recording devices belong to the same domain group when the content recorded in the first recording device is restored in the second recording device through the recording medium with the backup of the above content recorded;
restore permission means for permitting the second recording device to restore the content when the first and second recording devices belong to the same domain group, as a result of the check;
restore non-permission means for not permitting the second recording device to restore the content when the first and second recording devices do not belong to the same domain group, as a result of the check;
invalidation means for, when one of the recording devices connected through the communication network makes a request to refresh the domain group, invalidating the domain group to which the recording device belongs while keeping a history of the above domain group; and
refresh non-permission means for holding a refresh prohibition period and not permitting the refresh when one of the recording devices registered in the domain group makes a request for refresh before elapse of the refresh prohibition period.

8. A server which permits a plurality of reproduction devices registered in the same domain group to reproduce a content encrypted with a content key and having a domain group identification number inherent in a domain group recorded therein, comprising:
registration means for, upon receipt of a request for registration in the domain group from the reproduction device, together with the domain group identification number and a reproduction device identification number inherent in the reproduction device, recording the reproduction device identification number related to the domain group identification number, and registering the reproduction device in the domain group by recording the domain group identification number in the reproduction device of the registration request source;
user key delivery means for creating a user key for the reproduction device by using the reproduction device identification number after the reproduction device is registered in the domain group, recording the created user key related to the reproduction device identification number of the reproduction device, and delivering the user key to the registered reproduction device; and
content key delivery means for encrypting the content key with the user key created by the user key delivery means and delivering the encrypted content key to the registered reproduction device for the same reproduction device to encrypt the content with the encrypted content key.

9. The server according to claim 8, wherein
when a reproduction device is requested to reproduce a content permitted to be reproduced in reproduction devices belonging to some domain group and when a domain group identification number recorded in the request source reproduction device is identical to the domain group identification number of the requested domain group, a user key is delivered from the user key delivery means to the reproduction device, and when the user key is identical to the user key having been delivered from the user key delivery means, the reproduction device decodes the encrypted content key with the user key, and decodes and reproduces the content with the decoded content key.

10. The server according to claim 8, further comprising:
first checking means for checking whether the domain group identification number and the reproduction device identification number are recorded as being related to each other, upon receipt of a request for leaving the domain group together with the domain group identification number and the reproduction device identification number from the reproduction device registered in the domain group; and
registration cancellation means for, when the first checking means judges that the domain group identification number and the reproduction device identification number are recorded as being related to each other, deleting the related record of the domain group identification number and the reproduction device identification number as well as the domain group identification number recorded in the reproduction device, so as to cancel the registration of the reproduction device in the domain group.

11. The server according to claim 8, wherein
the domain group identification number, the user key, and the encrypted content key are recorded in the recording medium connected to the reproduction device, and a recording medium identification number inherent in the recording medium is used, instead of the reproduction device identification number inherent in the reproduction device, to record the recording medium identification number in the recording medium.

12. The server according to claim 8, further comprising:
second checking means for checking whether the domain group identification number and the reproduction device identification number are recorded as being related to each other, upon receipt of a refresh request for requesting a registration cancel of all the reproduction devices registered in the domain group together with the domain group identification number and the reproduction device identification number from the reproduction device registered in the domain group;
refresh permission means for permitting the refresh request when the second checking means judges that the domain group identification number and the reproduction device identification number are recorded as being related to each other and when the refresh request is made after elapse of a predetermined period from the last refresh request; and
refresh number giving means for, when the refresh request is permitted by the refresh permission means, executing a refresh of the respective reproduction devices registered in the domain group by deleting all the related records of the domain group identification number and the reproduction device identification number, and recording a refresh number indicating cumulative times of executing the refresh in the respective reproduction devices and the content.

13. The server according to claim 12, wherein
when a reproduction device makes a request to reproduce a content permitted to be reproduced in the reproduction devices belonging to some domain group, and when the domain group identification number recorded in the reproduction device of the request source is identical to the domain group identification number of the requested domain group and the refresh number recorded in the content is older than the refresh number recorded in the reproduction device of the request source, the user key is used to decode the encrypted content key and the decoded content key is used to decode and reproduce the content.

14. The server according to claim 8, wherein
the user key is delivered to the reproduction device through a protected communication channel.
